(19) United States
(12) Patent Application Publication
(10) Pub. No.: US 2026/0066532 A1
(43) Pub. Date: Mar. 5, 2026

(54) APPARATUS FOR CONNECTING A MONOLITHICALLY INTEGRATED CIRCUIT TO ANTENNA ELEMENTS OF AN ANTENNA ARRAY

(71) Applicant: Robert Bosch GmbH, Stuttgart (DE)

(72) Inventors: Christian Waldschmidt, Ulm (DE); Robin Bord, Dietenheim (DE)

(21) Appl. No.: 19/289,265

(22) Filed: Aug. 4, 2025

(30) Foreign Application Priority Data
Aug. 28, 2024 (DE) 10 2024 208 188.4

(51) Int. Cl. H01Q 1/52; G01S 7/03; G01S 13/931; H01Q 1/32; H01Q 21/00

(52) U.S. Cl. CPC H01Q 1/526; G01S 7/03; G01S 13/931; H01Q 1/3233; H01Q 21/0068

(57) ABSTRACT

An apparatus for connecting a monolithically integrated circuit to antenna elements of an antenna array including a decoupling unit for decoupling a signal emitted by the monolithically integrated circuit in the microwave range into a dielectric waveguide of a distribution network which includes dielectric waveguides and is designed to feed the decoupled signal into the antenna elements of the antenna array. Metal shields between adjacent dielectric waveguides of the distribution network shield the dielectric waveguides of the distribution network from one another.

### CROSS REFERENCE

The present application claims the benefit under 35 U.S.C. § 119 of Germany Patent Application No. DE 10 2024 208 188.4 filed on Aug. 28, 2024, which is expressly incorporated herein by reference in its entirety.

### FIELD

The present invention relates to an apparatus for connecting a monolithically integrated circuit to antenna elements of an antenna array, and in particular to a combination of dielectric and metallic components in antenna arrays for radar sensors.

### BACKGROUND INFORMATION

Conventional approaches for connecting an MMIC (microwave monolithic integrated circuit) to antenna elements are based exclusively on metallic components with high conduction losses. In particular large antenna arrays with a large number of antenna elements are subject to significant limitations due to high conduction losses caused by long feed lines.

Germany Patent Application No. DE 10 2015 221 803 A1 describes a radar sensor comprising a monolithically integrated microwave circuit (MMIC).

Conventionally, exclusively metallic components are used to connect an MMIC to antenna elements of an antenna array. The distribution network for the individual antenna elements is implemented with the aid of hollow conductors. Metallic structures are used for the antenna elements. An alternative option is to feed dielectric antenna elements with a dielectric waveguide. This makes it possible to implement antenna arrays with a small number of antenna elements and large antenna spacings.

In particular for antenna arrays with a large number of antenna elements, the conventional approach is to use exclusively metallic components to connect an MMIC to the antenna elements. In the field of automotive radar systems, the common approach is to use microstrip patch antenna arrays that have high losses. These high losses have a negative effect on the performance of the radar device, however. To avoid the dielectric losses of microstrip patch antennas, hollow conductor slot antennas can be used as an alternative. The existing approaches for connecting an MMIC to antenna elements using metallic components have high losses, which result in reduced radiation efficiency, in particular in the millimeter wave range. In the microstrip patch arrays currently being used, these losses can be attributed to the dielectric losses of the patch arrays and distribution network.

When metallic hollow conductors are used, ohmic losses due to surface currents occur as well in addition to the dielectric losses of a possible filler material. The cost-intensive and precise manufacturing required for metallic hollow conductors represents a further limitation of this type of conduction. With the trend toward better angular resolutions, two-dimensional radar systems with a large aperture are increasingly being used. The positioning of the antenna elements is limited here by the conduction losses of the long feed lines.

The use of exclusively dielectric components for the distribution network and the antenna elements is unsuitable for the implementation of antenna arrays with a large number of antenna elements and small antenna spacings. Due to the field guidance outside the dielectric waveguide, strong couplings occurs at short distances between adjacent waveguides or antenna elements. Exclusively dielectric components also have low mechanical stability, so that additional support structures are needed. Due to the low mechanical stability of antenna arrays with exclusively dielectric components, the scalability to antenna arrays with a large number of antenna elements is severely limited as well.

### SUMMARY

According to a first aspect, the present invention provides an apparatus for connecting a monolithically integrated circuit to antenna elements of an antenna array comprising a decoupling unit for decoupling a signal emitted by the monolithically integrated circuit in the microwave range into a dielectric waveguide of a distribution network which consists of dielectric waveguides and is designed to feed the decoupled signal into the antenna elements of the antenna array, wherein metal shields between adjacent dielectric waveguides of the distribution network shield the dielectric waveguides of the distribution network from one another.

The apparatus according to the present invention in particular enables the low-loss connection of an MMIC (microwave monolithic integrated circuit) to antenna elements of an antenna array. The transitions required for this are realized by a combination of dielectric and metallic components.

The apparatus according to the present invention enables the implementation of the distribution network for antenna arrays with low losses, a simple design, and low costs. The combination of dielectric and metallic components makes it possible to reduce the conduction losses of the distribution network of an antenna array compared to the previous use of exclusively metallic components.

MMICs (monolithic microwave integrated circuit) are a special class of integrated components, circuits, or systems in high-frequency technology and microelectronics. The active and passive components are implemented on a semiconductor substrate (typically 100 μm thick). Miniaturization enables circuits down to the millimeter-wave range. An MMIC (microwave monolithic integrated circuit) is a specialized type of integrated circuit intended for use in high-frequency and microwave applications.

A dielectric waveguide is a waveguide that guides electromagnetic waves through a dielectric medium. Unlike metallic waveguides, which are based on reflection from metal walls, dielectric waveguides use total reflection at the interfaces between different dielectric materials. A dielectric waveguide preferably consists of a core material with a high refractive index surrounded by a cladding material with a lower refractive index. This structure allows electromagnetic waves to be guided within the core by total reflection.

In one possible example embodiment of the apparatus according to the present invention for connecting a monolithically integrated circuit to antenna elements of an antenna array, the distribution network consisting of dielectric waveguides is provided on a metal surface. This increases mechanical stability.

The use of a dielectric waveguide on a metal surface also represents a low-loss and affordable option for simple design of a dielectric waveguide with a high relative bandwidth.

In one possible example embodiment of the apparatus according to the present invention for connecting a monolithically integrated circuit to antenna elements of an antenna array, the signal emitted by the monolithically integrated circuit in the microwave range is decoupled into the dielectric waveguide of the distribution network by means of a first wave-type converter, which is designed to feed the signal emitted in the microwave range into a hollow conductor, and by means of a second wave-type converter, which is designed to feed the signal fed into the hollow conductor into the dielectric waveguide of the distribution network.

In one possible example embodiment of the apparatus according to the present invention for connecting a monolithically integrated circuit to antenna elements of an antenna array, the signal emitted by the monolithically integrated circuit in the microwave range is decoupled into the dielectric waveguide of the distribution network by means of an on-chip antenna of the monolithically integrated circuit, which is designed to excite the fundamental mode in the dielectric waveguide of the distribution network.

This makes it possible to achieve direct coupling without the use of an intermediate hollow conductor.

According to an example embodiment of the present invention, an on-chip antenna can be used for the transition from an MMIC to a dielectric waveguide of the distribution network. This ensures efficient mode excitation in the dielectric waveguide.

In one possible embodiment of the apparatus according to the present invention for connecting a monolithically integrated circuit to antenna elements of an antenna array, the dielectric converter is coupled into the respective antenna element of the antenna array by means of a wave-type converter.

In one possible example embodiment of the apparatus according to the present invention for connecting a monolithically integrated circuit to antenna elements of an antenna array, the dielectric waveguides of the distribution network are attached by plugging them onto a metal surface and/or by clamping them between the metal shields. This makes it possible to facilitate the assembly. It also saves space.

The present invention further provides a radar sensor comprising an apparatus for connecting a monolithically integrated circuit to antenna elements of an antenna array according to the first aspect of the present invention.

The present invention also provides a vehicle with at least one radar sensor comprising an apparatus for connecting a monolithically integrated circuit to antenna elements of an antenna array according to the first aspect of the present invention.

### BRIEF DESCRIPTION OF THE DRAWINGS

FIG. 1 shows a schematic illustration of an apparatus according to an example embodiment of the present invention for connecting a monolithically integrated circuit to antenna elements of an antenna array.

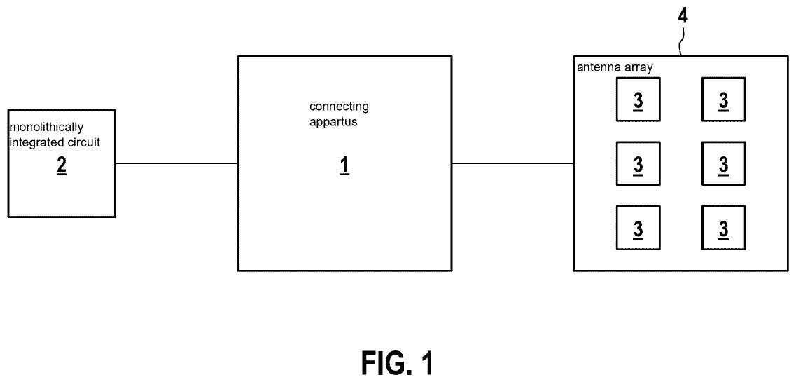

FIG. 2 shows a possible embodiment of an apparatus according to the present invention for connecting a monolithically integrated circuit to antenna elements of an antenna array.

### DETAILED DESCRIPTION OF EXAMPLE EMBODIMENTS

According to a first aspect, the present invention provides an apparatus 1 for connecting a monolithically integrated circuit 2 to antenna elements 3 of an antenna array 4 comprising a decoupling unit for decoupling a signal emitted by the monolithically integrated circuit 2 in the microwave range into a dielectric waveguide 5 of a distribution network 6 which consists of dielectric waveguides and is designed to feed the decoupled signal into the antenna elements 3 of the antenna array 4, wherein metal shields between adjacent dielectric waveguides 5 of the distribution network 6 shield the dielectric waveguides 5 of the distribution network 6 from one another.

The monolithically integrated circuit 2 connected by the apparatus 1 preferably comprises an MMIC (microwave monolithic integrated circuit). MMICs are a class of integrated components, circuits, or systems in high-frequency technology and microelectronics. The active and passive components can be implemented on a semiconductor substrate, which typically has a thickness of approximately 100 μm.

The MMIC 2 connected by means of the apparatus 1 is an integrated circuit designed for frequencies in the microwave range (typically from 1 GHz to over 100 GHz). “Monolithic” means that the entire circuit 2 is manufactured on a single semiconductor substrate, which results in a high degree of reliability and compact size. The MMIC 2 can be made of semiconductor materials such as gallium arsenide (GaAs), silicon (Si) or silicon-germanium (SiGe). The use of GaAs in particular provides excellent properties for high-frequency applications. The MMIC 2 comprises a variety of components, such as transistors (field-effect transistors (FET)), resistors, capacitors and inductors, that are all integrated on a single chip.

The MMIC 2 utilizes microwave circuitry techniques such as stripline or microstrip designs for transmitting high-frequency signals. The circuit elements are configured such that they are optimized for microwave frequencies. Because all of the components are integrated on a single chip, the MMIC 2 is compact in design and provides high power density. Monolithic integration minimizes the number of connections and connection errors, which increases the reliability of the MMIC 2. The MMIC 2 is specifically optimized for the microwave range and provides higher performance than discrete components in this frequency range.

In one possible embodiment of the apparatus 1 according to the present invention for connecting a monolithically integrated circuit 2 to antenna elements 3 of an antenna array 4, the distribution network 6 consisting of dielectric waveguides 5 is provided on a metal surface for mechanical stabilization. The use of a dielectric waveguide 5 on a metal surface represents a low-loss and affordable option for simple design of a dielectric waveguide 5 with a high frequency bandwidth.

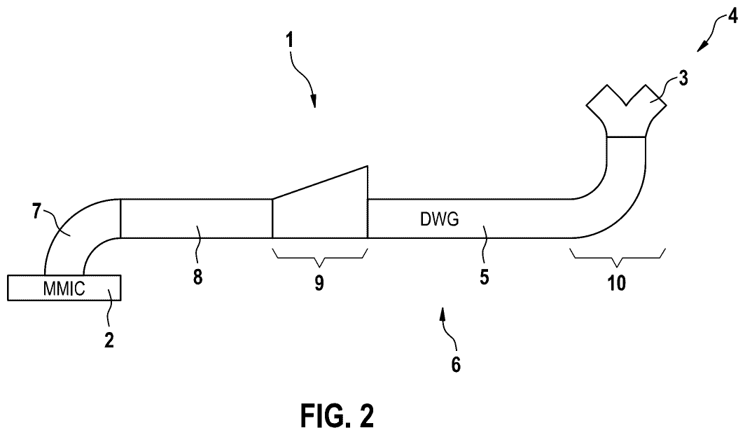

As shown in FIG. 2, in one possible embodiment of the apparatus 1 according to the present invention, the signal emitted by the monolithically integrated circuit 2 in the microwave range is decoupled into the dielectric waveguide 5 of the distribution network 6 by means of a first wave-type converter 7, which is designed to feed the signal emitted in the microwave range into a hollow conductor 8, and by means of a second wave-type converter 9, which is designed to feed the signal fed into the hollow conductor 8, into the dielectric waveguide 5 of the distribution network 6.

The monolithically integrated circuit 2 generates a microwave signal. This is a signal in the microwave range that is generated and emitted within the circuit. The hollow conductor 8 serves as transport medium for the microwave signal between the first wave-type converter 7 and the second wave-type converter 9. The hollow conductor 8 guides the microwave signal through conductive walls that hold and guide the signal within the hollow conductor 8. The second wave-type converter 9 receives the microwave signal from the hollow conductor 8 and converts it from the hollow conductor transmission mode to the transmission mode suitable for the dielectric waveguide 5. It ensures that the signal from the hollow conductor 8 is fed into the dielectric waveguide 5 of the distribution network 6. The dielectric waveguide 5 is a medium that is optimized for the transmission of microwave signals through dielectric materials. The signal is now transported through the dielectric waveguide 5, which is part of the distribution network 6.

In a possible alternative embodiment of the apparatus 1 according to the present invention for connecting a monolithically integrated circuit 2 to antenna elements 3 of an antenna array 4, the signal emitted by the monolithically integrated circuit 2 in the microwave range is decoupled into the dielectric waveguide 5 of the distribution network 6 by means of an on-chip antenna of the monolithically integrated circuit 2, which is designed to excite the fundamental mode in the dielectric waveguide 5 of the distribution network 6. An on-chip antenna circuit 2 can be used for the transition from the MMIC 2 to the dielectric waveguide 5. This ensures efficient mode excitation in the dielectric waveguide 5 of the distribution network 6.

The dielectric waveguide 5 can be coupled into the respective antenna element 3 of the antenna array 4 by means of a third wave-type converter 10, as also shown in FIG. 2.

The wave-type converters 7, 9, 10 of the embodiment of the apparatus 1 according to the present invention shown in FIG. 2 are crucial for adapting the transmission modes between different transmission media. Their function is to ensure that the signal is transmitted from one medium to the other without significant losses or reflections.

In one possible embodiment of the apparatus 1 according to the present invention for connecting a monolithically integrated circuit 2 to antenna elements 3 of an antenna array 4, the dielectric waveguides 5 of the distribution network 6 are mechanically attached by plugging them onto a metal surface and/or by clamping them between the metal shields.

According to a further aspect, the present invention further provides a radar sensor or radar device comprising an apparatus 1 for connecting a monolithically integrated circuit 2 to antenna elements 3 of an antenna array 4 according to the first aspect of the present invention. The radar device comprises a monolithically integrated circuit 2, which is connected to an antenna array 4 of the radar device via an apparatus 1. In one possible embodiment, the radar device comprises a two-dimensional radar device.

According to a further aspect, the present invention also provides a vehicle with at least one radar sensor or a radar device which includes an apparatus 1 for connecting a monolithically integrated circuit 2 to antenna elements of an antenna array 4 of the radar device. The vehicle can be a road vehicle, in particular a car or truck. The vehicle can also include an aircraft or a water vehicle.

The concept according to the present invention of combining dielectric and metallic components makes it possible to implement the distribution network 6 of an antenna array 4 with lower losses. The dielectric waveguides 5 of the distribution network 6 can be used to reduce limitations related to the positioning of the antenna elements 3 in the array design of the antenna array 4.

The combination of dielectric and metallic components is the significant technical difference between the apparatus 1 according to the present invention and the existing approaches for antenna arrays. With the aid of additional metallic structures, adjacent dielectric components can be shielded from one another in the apparatus 1 according to the present invention. If the distribution network 6 is also implemented on a metal surface using dielectric waveguides 5, mechanically stable antenna arrays 4 can be scaled to accommodate a large number of antenna elements 3. The concept according to the present invention of combining dielectric and metallic components enables the low-loss connection of an MMIC 2 to the antenna elements 3 of an antenna array 4.

For this purpose, in one possible embodiment of the apparatus 1 according to the present invention, the signal is fed from the MMIC 2 into a hollow conductor 8 by means of a first wave-type converter 7 and then from the hollow conductor 8 into a dielectric waveguide 5 of the distribution network 6 by means of a further wave-type converter 9.

Alternatively, in another possible embodiment of the apparatus 1 according to the present invention, for the transition from the MMIC 2 to the dielectric waveguide 5 of the distribution network 6, the signal can be fed directly from the MMIC 2 into the dielectric waveguide 5 of the distribution network 6 by means of a metallic feed structure. To couple the signal out of the MMIC 2, the fundamental mode is excited in the dielectric waveguide 5 by means of an on-chip antenna.

The fundamental mode in the dielectric waveguide 5 is the fundamental type of electromagnetic wave that is guided through the dielectric waveguide 5. This mode is the lowest order, has the simplest field distribution and the lowest losses. The fundamental mode is the simplest solution to the wave equations for the dielectric waveguide 5 and has no nodes (zero points) of the electrical field strength in the cross-section of the dielectric waveguide 5. The electric field of the fundamental mode is distributed symmetrically around the axis of the waveguide 5. In the cylindrical waveguide 5, the fundamental mode has a Gaussian intensity distribution in cross-section.

The distribution network 6 consists of dielectric waveguides 5, which are suitable for feeding the signal coupled out of the MMIC 2 into the corresponding antenna elements 3 of the antenna array 4 with low loss. Attaching the dielectric waveguides 5 to a metal surface also ensures the mechanical stability of the antenna array 4, in particular if there are a large number of antenna elements 3 with long feed lines. Metal shields between adjacent dielectric waveguides 5 also prevent the coupling of signals within the distribution network 6. The dielectric waveguides 5 of the distribution network 6 can be attached by plugging them onto the metal surface and clamping them between the metal shields.

In one possible embodiment of the apparatus 1 according to the present invention, the signal is fed into the antenna elements 3 of the antenna array 4 by means of a third wave-type converter 10 from the dielectric waveguide 5 to the respective antenna element 3. The decoupling of the individual antenna elements 3 is ensured by metal shields between adjacent antenna elements 3.

The apparatus 1 according to the present invention enables the implementation of the distribution network 6 for antenna arrays 4 with low losses, a simple design and low costs. The combination of dielectric and metallic components makes it possible to reduce the conduction losses of the distribution network 6 of an antenna array 4 compared to the previous use of exclusively metallic components. Metallic components enable the shielding of adjacent dielectric waveguides or antenna elements from one another. This makes it possible to reduce the coupling of adjacent dielectric waveguides or antenna elements, which enables smaller antenna spacings compared to the use of exclusively dielectric components.

Thanks to the low-loss distribution network 6, the apparatus 1 according to the present invention enables scaling to antenna arrays 4 with a large number of antenna elements 3. Since the limitations related to the positioning of the antenna elements 3 are reduced by the low losses of the dielectric waveguide 5, the design freedom in terms of array layout is increased. The performance of an antenna array can thus be optimized depending on the antenna positions, instead of minimizing the conduction losses of the distribution network by using the shortest possible feed lines.

What is claimed is:

1. An apparatus for connecting a monolithically integrated circuit to antenna elements of an antenna array, comprising:
a decoupling unit configured to decouple a signal emitted by the monolithically integrated circuit in a microwave range into a dielectric waveguide of a distribution network which includes dielectric waveguides and is configured to feed the decoupled signal into the antenna elements of the antenna array;
wherein metal shields between adjacent dielectric waveguides of the distribution network shield the dielectric waveguides of the distribution network from one another.

2. The apparatus according to claim 1, wherein the distribution network including the dielectric waveguides is provided on a metal surface for mechanical stabilization.

3. The apparatus according to claim 1, wherein the signal emitted by the monolithically integrated circuit in the microwave range is decoupled into the dielectric waveguide of the distribution network using a first wave-type converter, which is configured to feed the signal emitted in the microwave range into a hollow conductor, and using a second wave-type converter, which is configured to feed the signal fed into the hollow conductor into the dielectric waveguide of the distribution network.

4. The apparatus according to claim 1, wherein the signal emitted by the monolithically integrated circuit in the microwave range is decoupled into the dielectric waveguide of the distribution network using an on-chip antenna of the monolithically integrated circuit, which is configured to excite a fundamental mode in the dielectric waveguide of the distribution network.

5. The apparatus according to claim 1, wherein the dielectric waveguide is coupled into a respective antenna element of the antenna array using a third wave-type converter.

6. The apparatus according to claim 1, wherein the dielectric waveguides of the distribution network are attached by plugging the dielectric waveguides onto a metal surface and/or by clamping the dielectric waveguides between the metal shields.

7. An antenna array, comprising:
antenna elements; and
an apparatus for connecting a monolithically integrated circuit to the antenna elements of the antenna array, the apparatus including:
a decoupling unit configured to decouple a signal emitted by the monolithically integrated circuit in a microwave range into a dielectric waveguide of a distribution network which includes dielectric waveguides and is configured to feed the decoupled signal into the antenna elements of the antenna array,
wherein metal shields between adjacent dielectric waveguides of the distribution network shield the dielectric waveguides of the distribution network from one another.

8. A radar device, comprising:
an apparatus for connecting a monolithically integrated circuit to antenna elements of an antenna array of the radar device, the apparatus including:
a decoupling unit configured to decouple a signal emitted by the monolithically integrated circuit in a microwave range into a dielectric waveguide of a distribution network which includes dielectric waveguides and is configured to feed the decoupled signal into the antenna elements of the antenna array,
wherein metal shields between adjacent dielectric waveguides of the distribution network shield the dielectric waveguides of the distribution network from one another.

9. The radar device according to claim 8, wherein the radar device includes a two-dimensional radar device.

10. A vehicle, comprising:
at least one radar device, each radar device of the at least one radar device including:
an apparatus for connecting a monolithically integrated circuit to antenna elements of an antenna array of the radar device, the apparatus including:
a decoupling unit configured to decouple a signal emitted by the monolithically integrated circuit in a microwave range into a dielectric waveguide of a distribution network which includes dielectric waveguides and is configured to feed the decoupled signal into the antenna elements of the antenna array,
wherein metal shields between adjacent dielectric waveguides of the distribution network shield the dielectric waveguides of the distribution network from one another.

11. The vehicle according to claim 10, wherein the vehicle includes an on-road vehicle.
